(19) United States
(12) Patent Application Publication
(10) Pub. No.: US 2002/0104740 A1
(43) Pub. Date: Aug. 8, 2002

(54) Conveyor system pusher having equalized motion

(76) Inventor: Walter K. Franke, Fremont, CA (US)

Correspondence Address: Bruce H. Johnsonbaugh, Eckhoff, Hoppe, Slick, Mitchell & Anderson, 333 Market Street, Suite 3125, San Francisco, CA, 94105, US

(21) Appl. No.: 09/776,783

(22) Filed: Feb. 2, 2001

(51) Int. Cl. B65G 25/00

(52) U.S. Cl. 198/747

(57) ABSTRACT

A pusher for a conveyor system or accumulator is provided. The pusher has an equalized motion across its length which is created by a drive train linkage including first and second rack and pinion assemblies wherein the pinion gears rotate about a common axis and are joined together by a connecting rod. The drive train linkage allows the pusher bar to be actuated by a single pneumatic or hydraulic cylinder connected to the pusher bar outwardly of the rack and pinion drive linkage. Positioning the pneumatic drive cylinder outwardly of the support linkage achieves a lower profile than achieved by prior art pushers.

### BACKGROUND AND BRIEF SUMMARY OF THE INVENTION

The present invention relates generally to pushers used in conveyor systems and in accumulation devices. More particularly, the present invention provides a pusher having an equalized motion along its length. The equalized motion is provided by a novel drive train linkage including a pair of spaced apart rack and pinion drives that are connected by a single connecting rod joining the pinion gears together. The drive train linkage allows the pusher to be actuated by a single cylinder that may be mounted at one end of the pusher, allowing the assembly to have an extremely low profile.

Pushers are typically used in conveyor systems for transferring a series of items from a conveyor moving in a first direction to a conveyor moving perpendicularly to that first position. FIG. 8 of the drawings is a schematic representation of a typical prior art pusher wherein the pusher bar 2 is actuated by a pair of spaced apart cylinders represented by arrows 3 and 4. The difficulty with trying to synchronize the cylinders 3 and 4 is that, if the pusher bar becomes even slightly askew, as shown by the dotted line in FIG. 8, the items being moved by the pusher bar can jam the conveyor mechanism and result in very costly shutdowns. Pusher bars are typically 15 or 16 feet long. Synchronizing the action of cylinders 3 and 4 which may be spaced apart as much as 8 or 10 feet has proven to be difficult for these types of systems.

An alternate type of prior art pusher is shown schematically in FIG. 9 wherein the pusher bar 2 is driven by a single center mounted cylinder 5. The output of the center cylinder 5 is typically applied to the center of pusher bar 2. Application of a single cylinder as shown in FIG. 9 avoids the synchronization of spaced apart cylinders required by FIG. 8, but it results in other problems. The action of the pusher bar 2 as shown in FIG. 9 after some period of use will typically become askew as shown in phantom in FIG. 9, again resulting in costly shutdowns of the system.

Another aspect of prior art systems that tends to limit their performance is the overall height of the pusher mechanism. Both of the types of mechanisms illustrated in FIGS. 8 and 9 typically require the drive cylinders to be mounted vertically above or below portions of the pusher bar suspension mechanism. This results in a relatively high profile of the mechanism. The present invention provides a pusher bar having an extremely low profile. The present invention provides a pusher bar which achieves equalized motion across the length of the pusher bar. The equalized motion is achieved by using a novel drive train linkage wherein a pair of rack and pinion gears are connected by a shaft extending between the pinion gears so that the motion of the pusher bar is in effect equalized by having both ends of the bar driven by rack and pinion assemblies that are tied together.

Accordingly, a primary object of the present invention is to provide a pusher assembly for use in conveyor and accumulation systems having an equalized motion over the length of the pusher bar.

Another object of the invention is to provide a pusher bar assembly in which a single drive cylinder may be utilized and in which the single drive cylinder may be placed off-center and near an end of the pusher bar.

Still another object of the invention is to provide a pusher bar assembly for use in conveying systems and accumulation systems having an extremely low profile.

Still another object of the invention is to provide a pusher for use in conveyor systems and accumulators having a simple and rugged design which provides equalized motion over the length of the pusher bar.

Other objects and advantages of the invention will become apparent from the following description and the drawings wherein:

### BRIEF DESCRIPTION OF THE DRAWINGS

FIG. 1 is a plan view of the pusher according to the present invention shown in its retracted position;

FIG. 2 is a plan view of the pusher of FIG. 1 shown in its extended position;

FIG. 3 is a side elevational view of the pusher shown in FIGS. 1 and 2, illustrating its low profile;

FIG. 4 is a schematic representation of a portion of the drive train linkage showing the pusher bar in its retracted position;

FIG. 5 is a schematic representation of a portion of the drive train linkage shown in its extended position;

FIG. 6 is a schematic representation, not to scale, of the drive train linkage of the present invention, showing the pusher retracted;

FIG. 7 is a schematic of the linkage of FIG. 6 with the pusher in its extended position,

FIG. 8 is a schematic representation of a prior art pusher drive mechanism utilizing two spaced apart drive cylinders; and

FIG. 9 is a schematic representation of a prior art pusher utilizing a single center mounted drive cylinder.

### DETAILED DESCRIPTION OF THE DRAWINGS

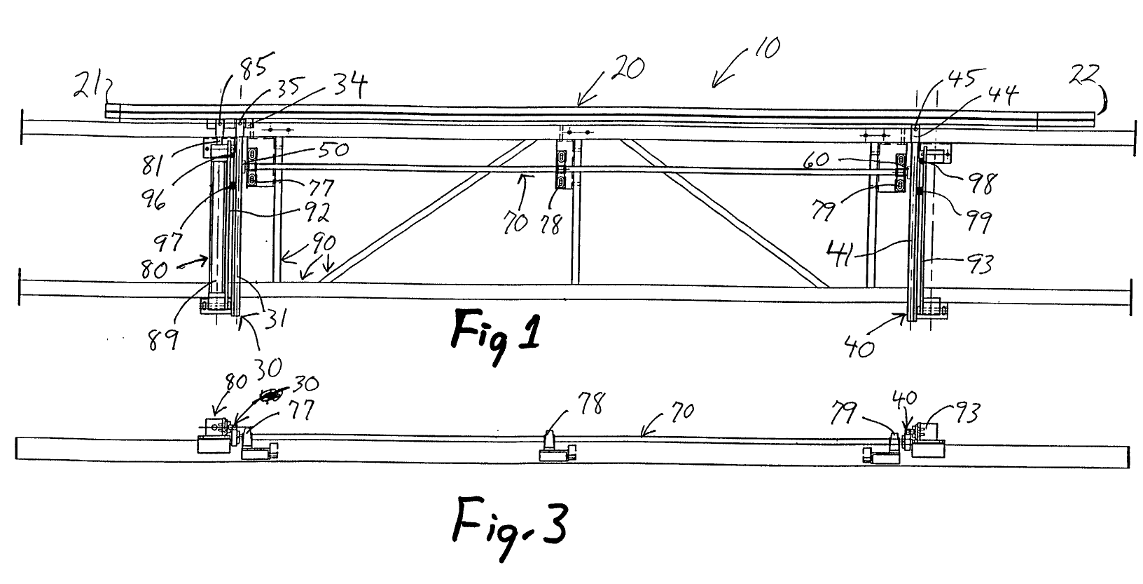

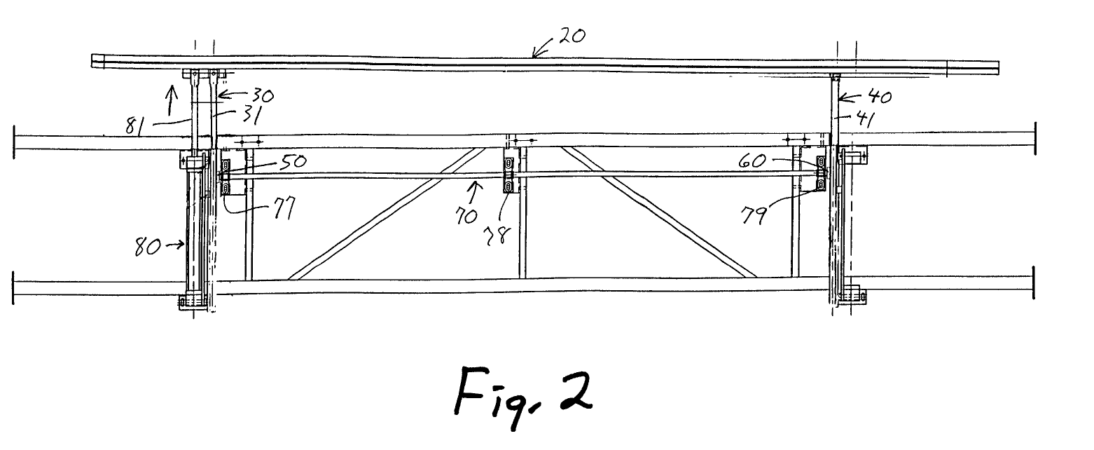

FIG. 1 illustrates the pusher 10 of the present invention. Pusher bar 20 is an elongated bar having a length, for example, from its first end 21 to its second end 22 of 16 feet. Pusher bars typically range anywhere from approximately 4 feet in length to more than 20 feet in length. Pusher bar 20 is movable between a first, retracted position illustrated in FIG. 1 and a second, extended position illustrated in FIG. 2.

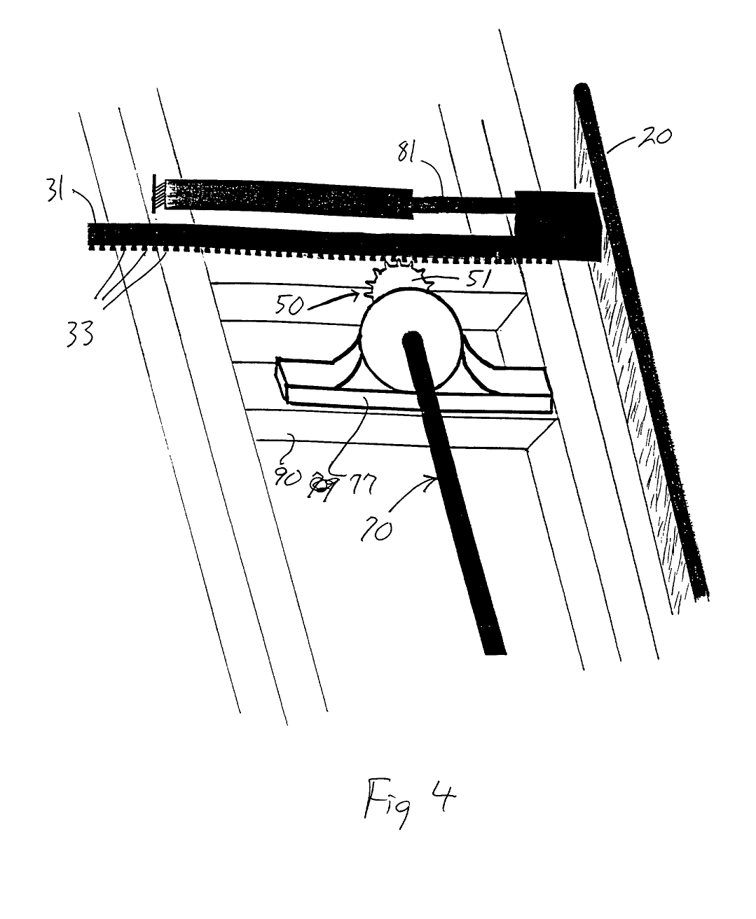

The weight of pusher bar 20 is carried by first and second rack means 30 and 40, respectively. Each of the rack means 30 and 40 includes an elongated rack 31 and 41, respectively, as shown best schematically in FIG. 4. Rack 31 has a series of teeth 33 carried along its lower surface. Rack 41 similarly has a set of teeth along its lower surface. Rack means 30 and 40 working together support the weight of pusher bar 20. Racks 31 and 41 are each connected to pusher bar by ears 34 and 44 and pins 35 and 45 that extend between the racks 31,41 and support ears 34 and 44. Each of the rack means 30 and 40 is movable between a retracted position illustrated in FIG. 1 and an extended position illustrated in FIG. 2. Rack means 30 and 40 are each supported by and slide on linear bearings 96,97 and 98,99, respectively. The linear bearings 96 and 97 are carried by frame member 92 which may be attached to the housing 89 of cylinder 80. Linear bearings 98 and 99 are carried by frame member 93.

Both the first and second rack means 30 and 40 ride above first and second pinion means 50 and 60. Pinion means 50 is illustrated schematically in FIG. 4 and includes pinion gear 51 carried on rod means 70. Rod means 70 is in turn carried by support bearings 77,78 and 79. Bearings 77-79 are carried on the machine frame 90. Rod means 70 connects first and second pinion means 50 and 60 together and both pinion means 50 and 60 rotate about a common axis of rotation. In this fashion, a unique drive train linkage is provided which includes both rack means 30 and 40, both pinion means 50 and 60 and the connecting rod means 70 connecting the individual pinion gears together. This drive train linkage allows the pusher bar to move between its retracted and extended positions with an equalized motion. Furthermore, the pusher bar 20 may be actuated by a single cylinder mounted off-center of pusher bar 20, as for example shown in FIGS. 1 and 2. Cylinder means 80 is positioned near the first end 21 of pusher bar 20. By positioning the cylinder means outwardly relative to the support members for the pusher bar, an extremely low profile for the pusher is achieved, as illustrated best in FIG. 3. The low profile afforded in FIG. 3 is in sharp contrast to prior art devices that position either a single cylinder or double cylinder at the center of the pusher bar in which case the cylinder assembly is typically positioned above the support assembly for the pusher bar, resulting in a considerable overall height of the device. By using the unique drive train linkage described above, a single drive cylinder means 80 can be utilized near either end of the pusher bar, reducing the overall vertical profile of the unit to less than half of that required by prior art pushers. Cylinder means 80 is connected to pusher bar 20 by a pin connection 85 that connects cylinder rod 81 to the mounting ear 34 to which rack 31 is pinned. Therefore, whenever the cylinder means 80 causes cylinder rod 81 to move, the rack 31 moves with cylinder rod 81, in turn causing the drive train linkage to move the pusher bar with an equalized motion between the first or retracted position, shown in FIG. 1, and the second extended position shown in FIG. 2. The drive train linkage allows a single off-center cylinder to be utilized and that single cylinder may be positioned anywhere along the length of pusher bar 20. Alternately, two cylinders could be provided to work together with the drive train linkage, but the preferred form of the invention utilizes a single pneumatic or hydraulic cylinder means 80 positioned adjacent the first rack and pinion means 30 and 40 as illustrated in FIGS. 1 and 2.

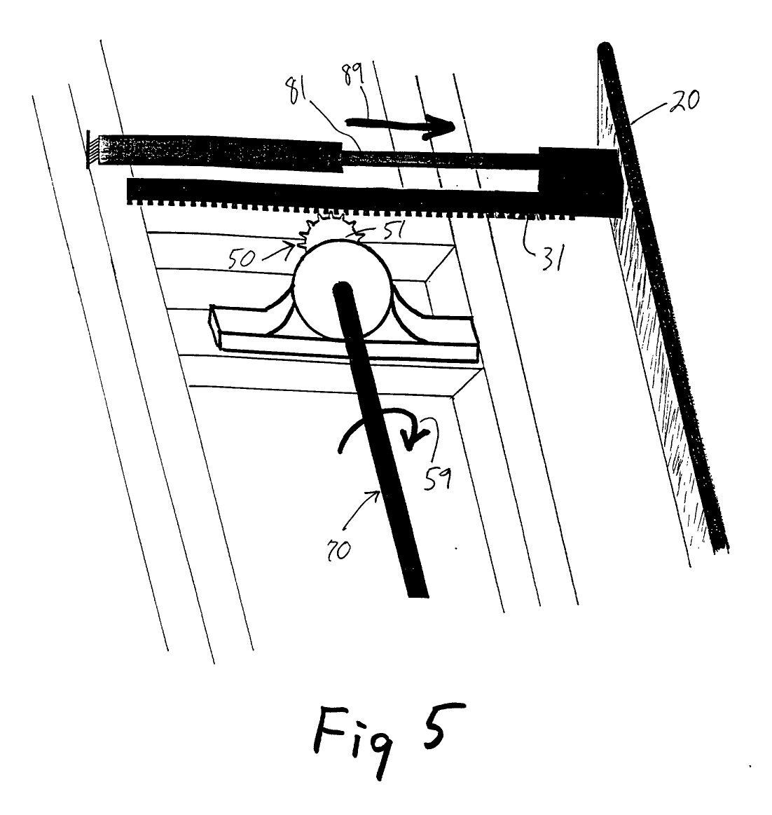

The schematic diagrams in FIGS. 4 and 5 show how the extension of cylinder rod 81, illustrated by arrow 89 in FIG. 5, causes the pusher bar 20 to be moved and simultaneously causes rack 31 to move in the direction of arrow 89. Such motion of rack 31 causes pinion gear 51 to rotate in the direction of arrow 59. That rotation causes the connecting rod 70 to rotate the second pinion means 60 and second rack means 40.

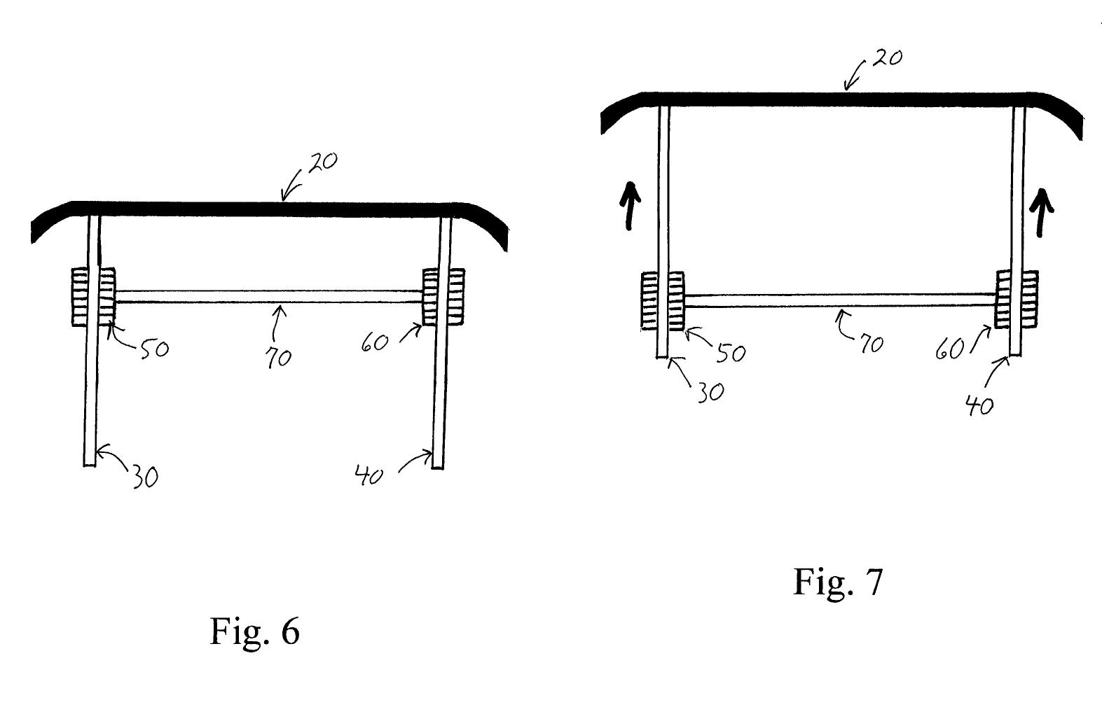

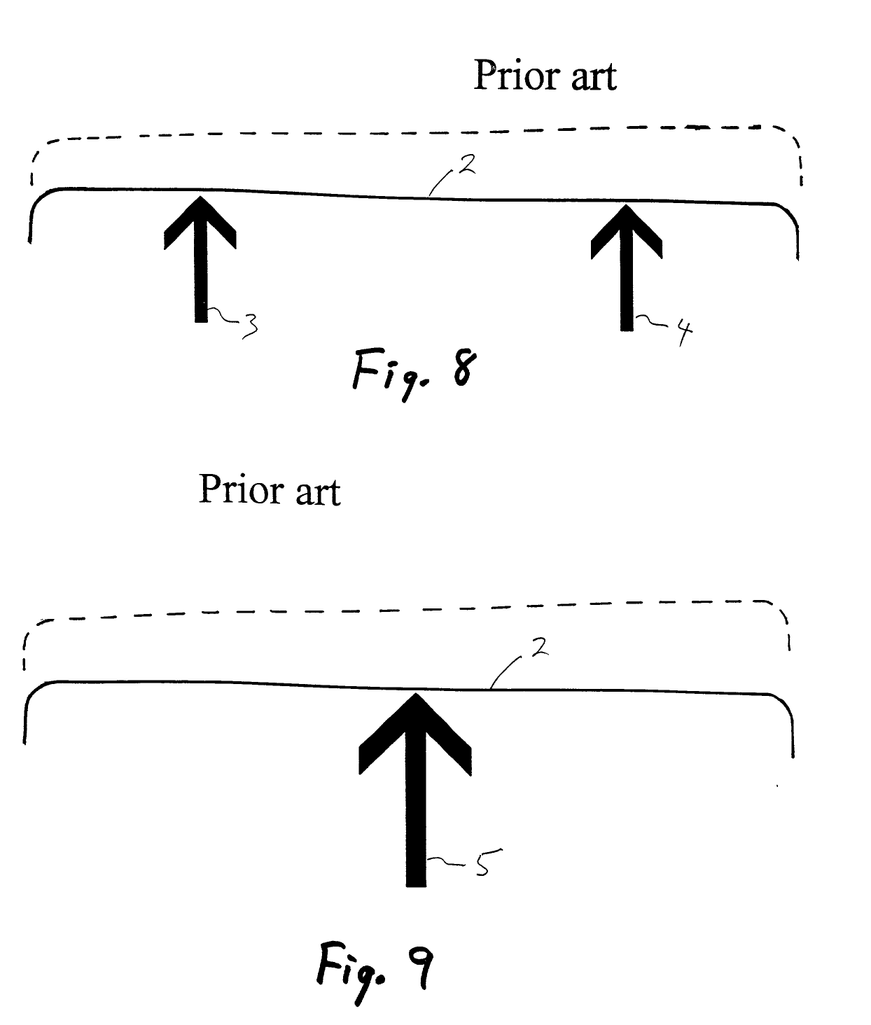

FIGS. 6 and 7 are schematics of the drive train linkage of the present invention, intentionally not to scale, and without the drive cylinder. The significance of FIGS. 6 and 7 is that the illustrated linkage assembly, including the pusher bar 20, both racks 30,40 and pinions 50,60 and connecting rod 70, provides an equalized motion of pusher bar 20 regardless of where a driving force is applied to pusher bar 20. A very smooth, even motion of pusher bar 20 is provided, regardless of where a force is applied against it. This linkage would be effective for pusher bars of greater length than 20 feet.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A pusher for a conveyor system having a single cylinder actuator and equalized motion comprising:
a pusher-bar movable between first and second positions,
first and second rack means connected to said pusher-bar for moving said pusher bar, said first and second rack means each being movable between a retracted position and an extended position,
first and second pinion means connected to said first and second rack means, respectively, said first and second pinion means rotatable about a common axis of rotation,
rod means connecting said first and second pinion means together along said axis of rotation, and
cylinder means connected to said pusher-bar for causing said pusher-bar to move between said first and second positions wherein the motion of said pusher-bar is equalized by the action of said first and second pinion means rotating together and causing said first and second rack means to move together with equalized motion between said retracted and extended positions.

2. The apparatus of claim 1 wherein said pusher bar has first and second ends and said cylinder means is connected to said first end of said pusher bar to achieve a low vertical profile.

3. The apparatus of claim 2 wherein said cylinder means comprises a single, pneumatic cylinder.

4. The apparatus of claim 1 further comprising a frame supporting said pusher bar and a plurality of linear bearings carried by said frame, said linear bearings being adapted to carry said rack means.
